(19) United States
(12) Patent Application Publication
(10) Pub. No.: US 2025/0196257 A1
(43) Pub. Date: Jun. 19, 2025

(54) DEVICE AND METHOD FOR PROCESSING A MATERIAL BY MEANS OF LASER PULSES THAT ARE INTRODUCED SPATIALLY STATISTICALLY AROUND A SPATIAL TARGET VALUE

(71) Applicant: TRUMPF Laser GmbH, Schramberg (DE)

(72) Inventors: Daniel Großmann, Schramberg (DE); Jonas Kleiner, Leonberg (DE); Marc Sailer, Villingen (DE)

(21) Appl. No.: 19/071,794

(22) Filed: Mar. 6, 2025

Related U.S. Application Data
(63) Continuation of application No. PCT/EP2023/073377, filed on Aug. 25, 2023.

(30) Foreign Application Priority Data
Sep. 9, 2022 (DE) 10 2022 122 964.5

(51) Int. Cl. B23K 26/0622; B23K 26/06; B23K 26/082; B23K 26/38

(52) U.S. Cl. CPC B23K 26/0624; B23K 26/0626; B23K 26/082; B23K 26/38

(57) ABSTRACT

A method for processing a material by using laser pulses of a pulsed laser includes introducing the laser pulses into the material in order to process the material. The laser pulses are introduced into the material in a distributed manner spatially statistically around a spatial target value. A spatial statistical distribution of the laser pulses is capable of being adjusted and adapted according to a current feed rate.

### CROSS REFERENCE TO RELATED APPLICATIONS

This application is a continuation of International Application No. PCT/EP2023/073377 (WO 2024/052137 A1), filed on Aug. 25, 2023, and claims benefit to German Patent Application No. DE 10 2022 122 964.5, filed on Sep. 9, 2022. The aforementioned applications are hereby incorporated by reference herein.

### FIELD

Embodiments of the present invention relate to a device and a method for processing a material by means of laser pulses of a pulsed laser.

### BACKGROUND

When processing a material with a pulsed laser, regular structures are often created, for example by a beating between the repetition rate and other process parameters such as the feed rate and the number of repetitions of material passes. Such regular structures can, for example, lead to interference effects that disturb the visual impression of the processed material.

A method and a device for laser cutting, in particular for laser cutting stents, are known from EP 3 613 228 A1.

A method for structuring a substrate surface is known from DE 10 2017 006 358 A1.

A processing process with a random trigger function for an ultrashort pulse laser is known from US 2018/0207748 A1.

### SUMMARY

Embodiments of the present invention provide a method for processing a material by using laser pulses of a pulsed laser. The method includes introducing the laser pulses into the material in order to process the material. The laser pulses are introduced into the material in a distributed manner spatially statistically around a spatial target value. A spatial statistical distribution of the laser pulses is capable of being adjusted and adapted according to a current feed rate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic structure of a device;

FIG. 2A, FIG. 2B, FIG. 2C and FIG. 2D show a schematic structure of the device according to some embodiments;

FIG. 3 shows a further schematic structure of the device according to some embodiments;

FIG. 4 shows a method;

FIG. 5A and FIG. 5B show a method according to some embodiments with a spatial statistical distribution of the laser pulses;

FIG. 6A and FIG. 6B show a method according to some embodiments with a spatial and temporal statistical distribution of the laser pulses;

FIG. 7 shows a further method according to some embodiments with a spatial and temporal statistical distribution of the laser pulses; and

FIG. 8 shows a further method according to some embodiments with a spatial and temporal distribution of the laser pulses.

### DETAILED DESCRIPTION

Embodiments of the present invention provide an improved method for processing a material and a corresponding device.

According to some embodiments, a method for processing a material by means of laser pulses of a pulsed laser is proposed, wherein the laser pulses are introduced into the material in order to process the material. According to embodiments of the invention, the laser pulses are introduced into the material in a distributed manner spatially statistically around a spatial target value.

Here, the material to be processed can be a material such as a metal foil, a polymer or a plastic. The material to be processed can also be a semiconductor, for example an elemental semiconductor such as silicon or germanium, or a III-V semiconductor such as gallium arsenide, or an organic semiconductor or any other type of semiconductor. By way of example, the material can be a silicon wafer. In particular, the material can be a layer system, wherein each layer may be chosen from the group of metals, polymers, plastics or semiconductors. In particular, the material can also be glass, for example sapphire.

In this case, the laser provides the laser pulses of the laser beam, wherein the individual laser pulses form the laser beam in the beam propagation direction. In particular, the laser can be an ultrashort pulse laser, wherein the pulse length of the individual laser pulses is preferably shorter than 10 ns, by preference shorter than 500 ps.

Instead of individual laser pulses, the laser can also provide laser bursts, wherein each burst comprises the emission of multiple laser pulses. In this regard, the laser pulses can be emitted very shortly after one another, spaced apart by a few picoseconds to nanoseconds, for a specific time interval. In particular, the laser bursts can be GHz bursts, in which the sequence of successive laser pulses of the respective burst occurs in the GHz range.

The laser pulses are introduced into the material, as a result of which the material can be processed. In this case, introduction can mean that the energy of the laser beam is at least partially absorbed within the material. Here, the focus of the laser beam can be located in the beam propagation direction above the surface of the material to be processed or under the surface, in the volume of the material to be processed. The focus position can also be located precisely on the surface of the material to be processed.

In particular, the term “focus” can generally be understood as a targeted increase in intensity, wherein the laser energy converges in a “focus region”. In particular, the term “focus” is therefore used below irrespective of the actual beam shape used and the methods used to bring about an increase in intensity. The location of the increase in intensity along the beam propagation direction can also be influenced by “focusing”. For example, the increase in intensity can be virtually punctiform and the focus region can have a Gaussian intensity cross-section, as is provided by a Gaussian laser beam.

The increase in intensity can also be linear, wherein a Bessel-type focus region is created around the focus position, as can be provided by a non-diffracting beam. Furthermore, other more complex beam shapes are also possible, the focus position of which extends in three dimensions, for example a multi-spot profile of Gaussian laser beams and/or non-Gaussian intensity distributions.

As a result of the energy absorbed from the laser beam, the material heats up in accordance with the intensity distribution of the laser and/or transitions into a temporary plasma state on account of the electromagnetic interaction between the laser and the material. In particular, in addition to linear absorption processes, non-linear absorption processes can also be used, which become accessible through the use of high laser energies or laser intensities. Accordingly, the material is modified particularly in the focus of the laser, as this is where the intensity of the laser beam is greatest. What this can achieve, in particular, is that some of the material can be detached from the material compound, the material for example melting or being evaporated. Hence, processing processes known per se are possible in relation to the interaction between the laser light and the material to be processed, these methods being known as laser drilling, percussion drilling or laser ablation, for example.

Due to the interaction of the laser pulses with the material to be processed, material modifications can also be incorporated or applied to the material.

A material modification can, for example, be a permanent modification of the network structure of the material or the (local) density of the material, which is caused by the local heating caused by the direct laser emission and the subsequent cooling and/or electronic relaxation processes.

The material modification in or on the material can, for example, be a modification of the structure, in particular the crystalline structure and/or the amorphous structure and/or the chemical structure and/or the mechanical structure, of the material.

The material modification is within the material if it is mainly introduced into the volume of the material. By contrast, the material modification is on the material if the material modification mainly modifies the surface of the material. In particular, a material modification can, however, be introduced into or applied to the material depending on the focus position and the beam profile of the laser beam.

A material modification can also be the direct change of a physical property, for example the strength and/or flexural strength and/or the tolerance of the material with respect to bending forces and shear forces and also shear and tensile stresses. In particular, a material modification can also be a local change in density, which can depend on the material selected. For example, density variations in the material can cause stress and compression zones which have a higher material hardness than the untreated material. It is also possible for a material modification to determine the visual properties of the material, for example by scattering light transmitted through a transparent material and making the material appear diffuse.

According to the method proposed here, the laser pulses are introduced into the material in a distributed manner spatially statistically around a spatial target value.

The spatial target value can, for example, be given by a point or a coordinate on the material. However, the spatial target value can also be given by a trajectory or a group of points on the material.

The spatial target value can correspond to the actual intended processing trajectory, for example a weld seam to be created, a separating contour to be introduced and/or a surface treatment to be introduced. In other words, the spatial target value is the spatial position at which the material processing has conventionally taken place and the laser pulses for processing have been introduced accordingly.

Spatially statistically distributed laser pulses around a spatial target value therefore have a statistical distribution of spatial distances from the spatial target value such that the laser pulses are introduced into the material at irregular distances from the spatial target value due to the spatial distribution.

However, the laser pulses also have a different distance from one another. The spatial distribution of the distances results in a spatial frequency distribution of the laser pulses introduced in the spatial frequency space, for example via a Fourier transformation. The more different the distances are, the greater the bandwidth of the spatial frequency distribution. In particular, both the distances to the spatial target value and the spatial frequency distribution can correspond to a statistical distribution.

This has the advantage that the laser pulses are introduced into the material at an irregular distance from one another such that disruptive optical effects, such as interference, are reduced or avoided.

The laser pulses can also be introduced into the material in a manner energetically statistically distributed around an energetic target value.

The energetic target value can, for example, be a correspondingly selected energy. Due to the different energies applied, the material modifications can vary in size, for example. This can further interrupt regularly occurring patterns on the processed material surface or in the processed material.

The laser pulses can be statistically distributed in at least one spatial dimension.

This can mean that the laser pulses can have a statistical distribution along an x-axis or a y-axis or a z-axis, for example.

However, this can also mean that the laser pulses can have such a statistical distribution in two or three dimensions.

For example, the laser pulses can have a Gaussian distribution along an x-axis. The distance between the laser pulses along the x-axis, for example, is then also distributed in a Gaussian manner. This is due to the fact that the Fourier transformation of a Gaussian function is also a Gaussian function.

For example, the laser pulses can also have a Gaussian distribution along an x-axis and a z-axis. The laser pulses are then distributed statistically along the surface and depth of the material.

The laser beam and the material can be displaced relative to one another by a feed.

“Displaceable relative to one another” means that both the laser beam can be displaced in translation relative to a stationary material and the material can be displaced relative to the laser beam, or both the material and the laser beam can be moved.

In particular, this allows the focus of the laser beam to be placed at different locations on the material in order to introduce laser pulses. In this case, the laser pulses are located in particular on the so-called feed trajectory. The feed trajectory can, for example, be straight or curved. In particular, the local feed direction is always the y-direction, while the z-axis is parallel to the surface normal and the x-axis is aligned perpendicular to the y-axis parallel to the material surface.

This, for example, allows the laser beam to be moved along with a feed while the laser pulses are emitted into or onto the material.

In particular, the laser pulses can be emitted with a temporal statistical distribution around a temporal target value during the feed.

As a result, a temporal statistical emission of the laser pulses in particular can lead to a spatial statistical distribution of the laser pulses in the material, wherein the feed is then preferably uniform.

If, for example, a sequence of laser pulses is emitted by the laser, the pulses are spaced apart in time. In particular, this results in a frequency of the laser pulse output in the frequency space from the course over time via a Fourier transformation. If the time intervals between the laser pulses are also different, the laser pulses are distributed around the frequency of the laser pulse output in the frequency space.

Laser pulses distributed statistically over time around a target value therefore exhibit a distribution of time intervals in relation to one another such that the temporal distribution results in the laser pulses being introduced into the material irregularly over time. The target value determines the temporal order of magnitude within which the laser pulse output takes place, while the statistical distribution determines the fine structure of the laser pulse output, so to speak. If the laser beam and the material are moved with a feed during exposure to the laser pulses, the temporal statistical distribution around the target value results in a spatial statistical distribution around a target value.

The temporal target value can, for example, be a base frequency of the laser or a system clock. However, the target value can also be a trigger signal of any kind.

The statistical distribution of the laser pulses can correspond to a Gaussian distribution or a uniform distribution or a triangular distribution or a sawtooth distribution.

For example, the spatial target value can correspond to the expected value of the Gaussian distribution and the statistical distribution can be characterized by a half-width. The expected value can, for example, be a straight trajectory on the material and the standard deviation can be 10 μm, in which case more than 68% of the laser pulses around the trajectory are emitted within ±10 μm.

For example, the spatial statistical distribution can be a uniform distribution, wherein each distance in an interval around a target value occurs with the same probability. The target value can, for example, be given by the center of the material. The interval can be ±100 μm around the center of the material surface. Then it is equally likely that the laser pulses have a distance of 7 μm, −8.5 μm, 9 μm, 9.3 μm, −12 μm, 56.2 μm, −99 μm and 100 μm to the center point.

The spatial statistical distribution can, for example, be a triangular distribution. Then the spatial target value can be the most probable value and the fluctuation range is determined by the length of the legs of the probability distribution. For example, the fluctuation range can be −5 μm to +10 μm, while the target value can be 20 μm relative to a currently approached point on the feed trajectory. Accordingly, the triangular distribution can exhibit an intrinsic asymmetry.

The spatial statistical distribution can, for example, be a sawtooth distribution. The most probable value can then be the spatial target value and the fluctuation range is determined by the length of the falling edges of the probability distribution. The target value can, for example, be 30 μm, while the fluctuation range amounts to +11 μm. The laser pulses then have a spatial distance of 30 μm to 41 μm accordingly.

The temporal target value can, for example, correspond to the expected value of the Gaussian distribution. The expected value can, for example, be given by a specific point in time and the standard deviation can be 20 μs, in which case more than 68% of the laser pulses around the trajectory are emitted within ±20 μs. For example, in the time-frequency space, the target value can be given by a frequency, such as the base frequency of the laser or a regular system clock. The laser pulses can then be distributed in the time-frequency space around the base frequency according to an expected value.

The energetic statistical distribution can, for example, be a sawtooth distribution. The target value can, for example, be 0.1 mJ, while the fluctuation range is +0.4 mJ. The laser pulses then have a corresponding energy in the range from 0.1 mJ to 5 mJ.

In particular, the laser pulses can have a spatial statistical distribution and an energetic statistical distribution and/or a temporal statistical distribution.

In general, the statistical distribution can also be composed of different statistical distributions. For example, it is possible to superimpose a normal distribution and a uniform distribution. However, it is also possible for the statistical distribution to be skewed. For example, the Gaussian distribution can also have a skew.

The statistical distribution of the laser pulses makes it particularly easy to interrupt and randomize a regular structure.

In particular, the statistical distribution can be adjustable.

For example, the half-width of a Gaussian distribution can be adjustable or the expected value of the distribution can be adjustable.

For example, the temporal distribution can be set more precisely than 1 μs. This can mean that the temporal output of the laser pulse is set to an accuracy of exactly 1 μs such that the temporal laser pulse output follows the desired temporal distribution.

In particular, the feed rate can be selected such that laser pulses emitted in immediate succession do not overlap.

This is particularly the case if the feed rate is greater than the ratio of the diameter of the laser focus and the time interval between the laser pulses.

If this minimum feed rate is exceeded, the material modifications introduced do not overlap. In particular, this achieves a single-pulse modification that is not based on the heat accumulation of successively introduced pulses.

For example, the diameter of the laser focus is 5 μm and the repetition rate of the laser pulses is 10 kHz. This results in a minimum feed rate of 0.5 m/s.

In particular, the variation of the spatial and/or temporal distribution can be adapted, for example, in curves that are typically traversed at a lower speed. This prevents laser pulses introduced one after the other from overlapping in the workpiece.

For example, at constant time intervals, successive laser pulses would overlap in the material at a low speed. If, on the other hand, the temporal statistical distribution is widened, for example by increasing the standard deviation and/or the expected value, such an overlap can be avoided.

The statistical distribution of the laser pulses can be adjusted according to the current feed rate.

This can mean that a first statistical distribution is used for a first, low feed rate and a second statistical distribution is used for a second, higher feed rate.

For example, a uniform distribution of the laser pulses can be used at a low feed rate, as the spatial distance between the laser pulses must be kept as large as possible in order to avoid pulse overlap. At the same time, with a higher feed rate, it can be useful to distribute the laser pulses in a Gaussian distribution such that the laser pulses are more concentrated on the feed trajectory.

However, it is also possible that the fluctuation range (for example the expected value) is adjusted to be smaller at higher feed rates, i.e., at higher feed rates, such that the actual spatial fluctuation range of the laser pulses on the material is always similar or the same.

In particular, the temporal statistical distribution can be adjusted with respect to the feed rate such that, for example, the spatial statistical distribution generated by the laser pulses on the material remains the same or changes while the feed rate is varied.

The statistical distribution can be adjusted depending on the process phase.

For example, a first statistical distribution can be useful for a first processing process and a second statistical distribution can be useful for a second statistical process.

For example, when processing a surface, it can be useful to use a meandering feed trajectory, wherein the laser pulses are spatially distributed in a Gaussian manner around the meander. By approaching neighboring lines of the meander antiparallel to one another and overlapping the Gaussian distribution on the edges, a homogeneous processing of the material can be achieved on the surface.

In a separating process, on the other hand, it can be advantageous if the material is processed in a leading manner in the direction of the feed trajectory, i.e., if laser pulses are partially placed in front of the target position of the laser beam. For example, a spatial sawtooth distribution can be used accordingly in order to achieve a particularly clean separation of the material. In this case, laser pulses would be directed sporadically in front of the current position of the laser beam in the feed direction such that the material is already weakened there in a targeted manner. Accordingly, a targeted crack propagation could take place from the current location of the laser beam, which for example corresponds to the target value, to the isolated position of the laser pulse.

The present method according to embodiments of the invention can be advantageously used in numerous processing processes.

For example, the processing process of the material can be a separating process or a deep engraving process in which material is removed in multiple passes with a small spatial overlap of successive laser pulses. By randomizing the laser pulse output in the feed direction, a uniform distribution of the laser pulses can be achieved, resulting in a high-quality cutting edge or engraving. In particular, the engraving is then free of periodic structures such that there are no disruptive diffraction phenomena that could impair the visual impression.

The processing process can also be used for metal structuring or surface removal. In this case, the visual impression depends heavily on the surface quality. In particular, the randomization of the laser pulses ensures that no unwanted patterns are imposed on the surface of the material.

Another important processing process is the so-called dimple structuring of a surface for anti-glare functionalization. In other words, dimples or craters can be imposed on the surface of the material by means of the laser pulses, on which the incident light is scattered. This allows a matte surface finish to be achieved on the material.

In particular, the method according to embodiments of the invention can be used to achieve particularly advantageous visual and haptic target properties of a material after dimple structuring. For example, such a dimple structuring can be used when processing a display glass, in particular a cover glass. For example, the sparkle, a measure of the irregular intensity and color fluctuations, can be set. In this regard, the sparkle is related to the size of the dimples. In particular, the sparkle can be set to less than 4%. If the glass is placed over a display with a particularly high resolution, it is advantageous to reduce the size of the dimples in order to ensure a low sparkle value.

Another important parameter is referred to as distinctness of image. This parameter is a measure of the clarity of the user information to be read. In this context, the distinctness of image scales inversely with the scattering or diffusion of light through the display cover glass. The distinctness of image can be set to more than 70% using the method according to embodiments of the invention. In particular, the distinctness of image can be set via the area filling of the display glass with the dimples, wherein the area filling constitutes preferably between 40% and 95% of the display area.

Another important parameter is the diffusion, which is a measure of the scattering strength of the display glass. In particular, the diffusion also depends on the shape and composition of the individual dimples. For example, the diffusion of the display glass can be set to more than 22%.

In addition, the method according to embodiments of the invention can avoid a moiré effect, which typically occurs when the pixel period of the display panel is of the same order of magnitude as the period of the dimple arrangement. By randomly introducing the dimples into the display glass via a statistical distribution, a moiré effect can be avoided.

In particular, the material modification can also take the form of bumps, i.e., elevations in the material, which are created by the brief melting and thermal expansion of the material.

In particular, the material modifications, in particular the elevations and indentations, also achieve a haptic change in the material surface.

Roughness, for example, can serve as a haptic target value. In particular, the haptic impression can be adjusted by the density of the modifications. A higher density typically creates a stronger or rougher haptic impression.

By means of a successive interaction of the same material region with at least two laser pulses, so-called laser-induced periodic surface structures (LIPSS) can also be generated.

In this regard, dimples and LIPSS are suitable for the functionalization of component surfaces, wherein visual properties, wetting properties and tribological properties can, in particular, be influenced.

In a particularly preferred embodiment, the method produces dimples with a diameter between 13 μm and 20 μm, wherein the laser-induced periodic surface structures have a periodicity of between 650 nm and 1000 nm.

Advantageous further developments of the method may be found in the dependent claims, the present description, and the figures.

Accordingly, a device for processing a material is proposed, comprising a system clock generator designed to provide a system clock signal, a statistics generator designed to receive the system clock signal, to impose a temporal statistical distribution on the system clock signal and to provide a statistics clock signal, a laser designed to receive the statistics clock signal or the system clock signal and to emit a laser pulse when the clock signal is received, a feed device designed to move the laser beam and the material relative to one another and a processing optical unit designed to transfer the laser beam to a focus zone and to introduce it into the material, thereby processing the material.

The system clock generator can provide the clock in the entire device such that all devices used can synchronize to a common clock. In this regard, the system clock generator outputs, for example, a pulsed base signal with a base frequency.

It is also possible that the base signal of the system clock generator corresponds directly, for example, to the temporal target value of the statistical distribution of the temporal pulse output. However, it is also possible that the base signal must be passed through a suitable multiplier in order to provide the target value of the temporal pulse output. The former is always assumed in the following. However, it is also possible that the system clock generator only outputs isolated signal pulses as a system clock signal, i.e., the system clock signal does not have a fixed base frequency.

The system clock generator can, for example, be built into the pulsed laser itself and correspond to the repetition rate, for example, or be an external pulse generator. However, it is also possible that the system clock appears irregular and merely represents a general trigger signal and is output by a feed device or a position offset device.

The statistics generator receives the system clock signal and can impose a statistical distribution on the signal pulses of the system clock signal. For example, the signal pulses can have a Gaussian distribution around the original signal pulses.

The statistics generator can, for example, be an FPGA or a computer or a microchip or an application-specific integrated circuit (ASIC) or a microcontroller. This makes it particularly easy to set various statistical distributions, for example.

The statistics clock signal can be received by the laser, which preferably is equipped with pulse-on-demand functionality. Accordingly, the laser emits a laser pulse each time it receives a pulse from the system clock signal. The laser pulses emitted therefore have the same course over time as the pulses of the statistics clock signal. In other words, the pulse-on-demand signal from the system clock generator for the pulsed laser is manipulated by means of the statistics generator.

In this regard, the statistical variation of the received pulses of the base signal can be effected by the statistics generator with a clock rate of over 1 MHz. This has the advantage that even at a very high clock rate, the statistics generator can still reliably impose the same statistical distribution on the pulses of the base signal.

The device furthermore has a processing optical unit that can focus the laser beam into the material. In particular, the processing optical unit can convert an angular offset into a spatial offset such that a statistical spatial deflection is generated particularly easily in the case of a statistical angular deflection described below.

The laser beam can be focused into/onto the workpiece by means of the processing optical unit or a scanner unit, wherein the processing optical unit has a numerical aperture of NA>0.01 and the scanner unit has a numerical aperture of NA<0.1.

For example, the processing optical unit has a numerical aperture of between 0.01 and 0.2, in particular of 0.04.

The numerical aperture NA essentially indicates the opening angle of the laser beam in the focus, wherein a large numerical aperture means a large opening angle. This allows the expansion of the focus zone in the beam propagation direction to be adjusted and thus also the size of the material modification in the beam propagation direction.

The device can also comprise a feed device that moves the laser beam and the material relative to one another.

The feed device can preferably comprise an axis device and/or a scanner device.

For example, the axis device can be used to move the material mechanically, while a scanner device is used to move the laser beam over the material. In particular, the axis device can be an XYZ table with a stepper motor control. However, it is also possible that the axis device is designed with piezo adjustments in order to achieve the fastest possible adjustment. In particular, the scanner device can be a galvo scanner. However, it is also possible that the feed device is a roll-to-roll device.

The feed device can receive the system clock.

For example, the system clock can be used to clock a stepper motor such that a certain number of steps are performed per second. The feed rate can therefore be set particularly easily by adjusting a multiplier on the motor. For example, the system clock can be a regular clock with which the scanner periodically deflects the laser beam over the material.

The feed device can receive the statistics clock signal.

For example, the feed device can then form an uneven feed trajectory. This also generates a statistical distribution around the feed trajectory, in particular also in the direction of the feed trajectory.

However, it is also possible for the feed device to provide the system clock.

The feed device thus outputs the system clock itself, which is sent to the statistics generator. This eliminates the need for an external component to generate a system clock and the laser pulse output is automatically adapted to the feed device and thus to the current position and speed.

In the simplest case, the feed device can output a system clock signal each time it has been moved by a certain length. The laser pulses can then be emitted automatically depending on the distance traveled and independently of the feed rate. In this case, this is referred to as a position-synchronous signal, which is output by the feed device. In particular, the current speed can be estimated from the position-synchronous signal in order to adjust the statistical distribution if necessary.

The device can have a position offset device that is designed to receive the statistics clock signal and to impose a spatial statistical distribution around a spatial target value on the laser pulses.

In particular, the position offset device can be an electro-optical and/or acousto-optical deflector and/or be based on coherent beam combining. The position offset device can receive the statistics clock signal and deflect the laser pulse accordingly.

In an acousto-optical deflector, an alternating voltage is applied to a piezo crystal in an optically adjacent material in order to generate an acoustic wave that periodically modulates the refractive index of the material. Here, the wave can propagate through the optical material, for example as a propagating wave or as a wave packet, or be in the form of a standing wave. Owing to the periodic modulation of the refractive index, a diffraction grating for an incident laser beam is realized here. An incident laser beam is diffracted at the diffraction grating and thus at least partially deflected at an angle to its original beam propagation direction. The grating constant of the diffraction grating and thus the deflection angle depends, among other things, on the wavelength of the acoustic wave and thus on the frequency of the applied alternating voltage.

Electro-optical deflectors are based on prisms made of electro-optical crystals. By applying a voltage, the refractive index of the electro-optical crystal is changed such that the path of the laser beam through the prism changes.

The spatial statistical distribution with an electro-optical and/or acousto-optical deflector can be implemented with a clock rate of over 1 MHz. Accordingly, the laser pulse can be repositioned several million times per second. In particular, the electro-optical and/or acoustic deflectors can be used to reposition the laser pulses with single-pulse precision such that each individual laser pulse is introduced at a different location on the material.

However, the position offset device can also be a wobble prism. In this case, a wobble prism comprises a prism that deflects the laser beam at an angle. A mechanical deflection of the prism achieves a spatial deflection of the laser beam.

The wavelength of the laser pulses can be between 200 nm and 3000 nm. This makes it possible to adapt the method to many different materials and processing processes.

The repetition rate of the laser can be between 10 kHz and 100 MHz, in particular between 19 kHz and 2 MHz. In this regard, the repetition rate determines the time interval at which at least two successive laser pulses are emitted.

The laser pulse can be composed of a plurality of laser burst pulses, in particular it can be composed of 2 to 100 laser burst pulses. In this regard, the laser burst pulses can be emitted at a particularly high frequency of over 1 GHz instead of a single laser pulse. In this case, the single laser burst pulse deflection is used instead of the single pulse deflection.

The fluence can be greater than 0.05 J/cm\hat{ }2, in particular between 0.1 J/cm\hat{ }2 and 50 J/cm\hat{ }2. This makes it possible to adapt the method to many different materials and processing processes.

The laser pulse duration can be between 10 fs and 100 ns, in particular between 100 fs and 100 ps.

For example, the length of the laser pulses can be between 100 ps and 100 ns, in particular between 1 ns and 20 ns, wherein the wavelength can be between 300 nm and 550 nm, in particular 355 nm, wherein the repetition rate of the laser pulses can be between 10 kHz and 100 kHz, in particular between 10 kHz and 50 kHz, wherein the laser pulses can have an energy between 60 μJ and 300 μJ and 1 to 4 pulses can be emitted per spot.

For example, the length of the laser pulses can be between 200 fs and 1000 fs, in particular between 300 fs and 450 fs, wherein the wavelength can be between 900 nm and 2300 nm, in particular 1030 nm, wherein the repetition rate of the laser pulses can be between 10 kHz and 400 kHz, wherein the laser pulses are emitted in laser bursts, wherein each laser burst can contain between 2 and 4 laser pulses, wherein the laser bursts can have an energy between 100 μJ and 400 μJ and the numerical aperture can be between 0.01 and 0.2, in particular 0.08.

In particular, the laser can also comprise an unstable seed laser and an amplifier, wherein the unstable seed laser includes the statistics generator and emits laser pulses with a temporal statistical distribution, wherein the amplifier amplifies the laser pulses of the seed laser.

The laser beam can also have a Gaussian beam shape or a non-diffracting beam shape.

Gaussian beams are in particular to be understood as beams whose intensity cross-section corresponds to a Gaussian bell curve.

Non-diffracting beams and/or Bessel-type beams are in particular to be understood as beams for which a transverse intensity distribution is propagation-invariant. In particular, for non-diffracting beams and/or Bessel-type beams, a transverse intensity distribution along a longitudinal direction and/or propagation direction of the beams is essentially constant.

With respect to the definition and properties of non-diffracting beams, reference is made to the book: “Structured Light Fields: Applications in Optical Trapping, Manipulation and Organisation”, M. Wördemann, Springer Science & Business Media (2012), ISBN 978-3-642-29322-1. Full explicit reference is made thereto.

Accordingly, non-diffracting laser beams are advantageous in that they may have an intensity distribution which is elongated in the beam propagation direction to a greater extent than the transverse dimensions of the intensity distribution. In particular, this renders possible the production of material modifications which are elongated in the beam propagation direction, with the result that these can penetrate the two sides of the workpiece particularly easily.

Furthermore, the laser beam can have a flat-top beam shape and/or a super-Gaussian beam shape and/or a top-hat beam shape.

Preferred exemplary embodiments are described below with reference to the figures. In this case, elements that are the same, similar or have the same effect are provided with identical reference signs in the different figures, and a repeated description of these elements is omitted in some instances, in order to avoid redundancies.

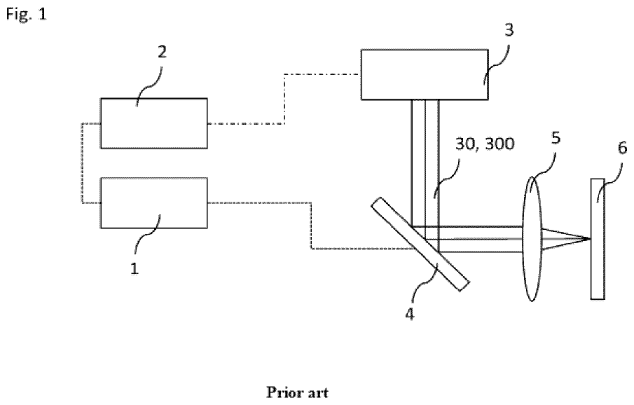

FIG. 1 schematically shows a device according to embodiments of the invention for processing a material 6. Here, the device has a system clock generator 1. The system clock generator 1 preferably outputs signal pulses of a fixed frequency, this being the system clock signal. In particular, the system clock generator 1 can be a pulse generator. However, it is also possible that the system clock generator 1 is intrinsically formed in one of the other installed device elements, as described below.

The system clock generator 1 is designed to send the system clock signal to the statistics generator 2. The statistics generator 2 receives the pulsed base signal from the system clock generator 1 and can impose a statistical distribution on the pulses of the base signal. In particular, the statistics generator 2 can vary the intervals between the pulses of the system clock signal in such a way that the signal pulses of the system clock signal exhibit a statistical distribution. For example, the intervals between the pulses of the base signal can be adjusted for this purpose. For example, the statistical distribution can result from the time intervals between the adjusted signal pulses and the unchanged pulses of the system clock signal.

These statistics clock signals can be received by the laser 3. For each signal pulse received by the laser 3, the laser 3 can emit a laser pulse 300 that propagates along the laser beam 30 of the laser 3. This functionality is also referred to as pulse-on-demand. The laser pulse 30 can then be focused by a processing optical unit 5 into a material 6 or onto the surface of a material 6. Accordingly, the laser pulses 300 are introduced with the statistical distribution of the statistics generator 2.

The laser pulse 300 can effect a material processing in the material 6 such that processing of the material 6 occurs.

The feed device 4 can move the material 6 and the laser beam 30 relative to one another such that the laser beam 30 is moved along the feed trajectory with a feed. For example, the feed device here is designed as a scanner device with which the laser beam 30 is periodically moved over the material 6. When the laser pulses 300 with the statistical distribution are triggered during the feed and introduced into the material 6, the material modifications are also present in the material 6 in a certain statistical distribution. In particular, it should be emphasized here that the statistical distribution of the laser pulses 300 is a temporal distribution, while the statistical distribution of the material modifications in the material 6 exhibit a local statistical distribution due to the simultaneous feed.

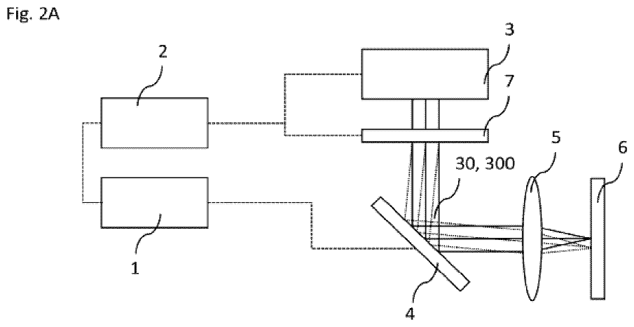

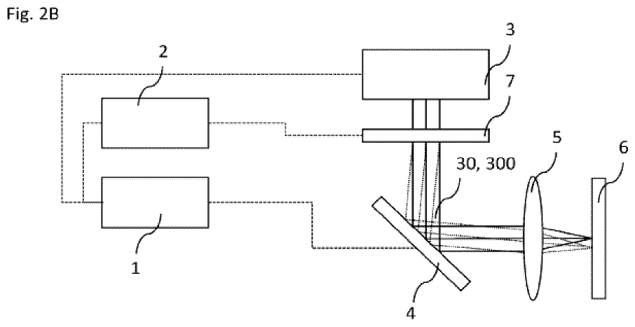

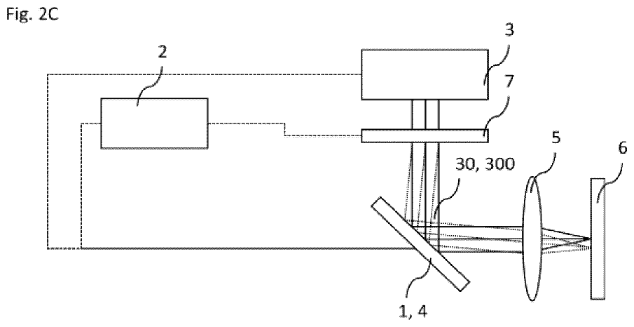

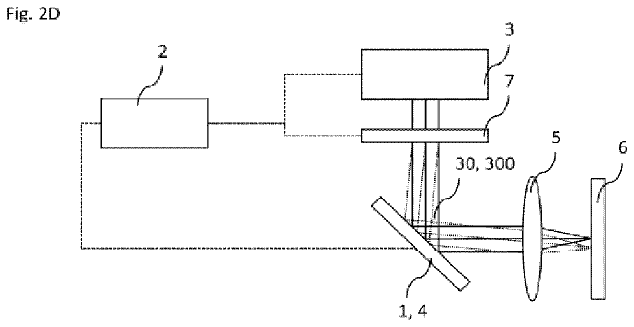

A device according to embodiments of the invention is shown in FIG. 2A. Here, the pulse generation of the laser 3 is carried out analogously to FIG. 1. However, a position offset device 7 is arranged behind the laser 3 in the beam propagation direction. The position offset device 7 can be an acousto-optical deflector, for example. The acousto-optical deflector 7 also receives the signal from the statistics generator 2 and can accordingly spatially deflect a laser pulse 300 triggered by the laser 3. In this case, the temporal deviation of the signal pulse from the base frequency can be translated into a spatial deflection, for example. At the same time, the laser 3 can receive the statistics clock signal from the statistics generator 2 and impose a temporal variation on the laser pulses 300.

However, it is also possible, as shown in FIG. 2B, that only the position offset device 7 effects a spatial statistical distribution of the laser pulses 300 and that the laser 3 is operated via the system clock generator 1. The laser 3 then emits laser pulses 300 at regular intervals according to the base frequency and only the position offset device generates the spatial statistical distribution of the laser pulses 300.

However, it is also possible, as shown in FIG. 2C, that the feed device 4 outputs the system clock signal and thus triggers a laser pulse 300 after a certain distance has been traveled, for example. In addition, the system clock signal can be influenced by the statistics generator 2 such that the position offset device 7 effects an additional spatial statistical distribution of the laser pulses 300.

It is also possible, as shown in FIG. 2D, for the feed device 4 to output the system clock signal and for the system clock signal to be influenced by the statistics generator 2. In particular, the laser 3 can thus receive the statistics clock signal, which can be used, for example, to implement a pulse triggering according to the statistical distribution. In addition, the position offset device 7 can effect a spatial statistical distribution of the laser pulses 300 by means of the received statistical signal.

It is also possible for the laser 3 to also receive the statistics clock signal, thereby imposing an additional temporal statistical distribution.

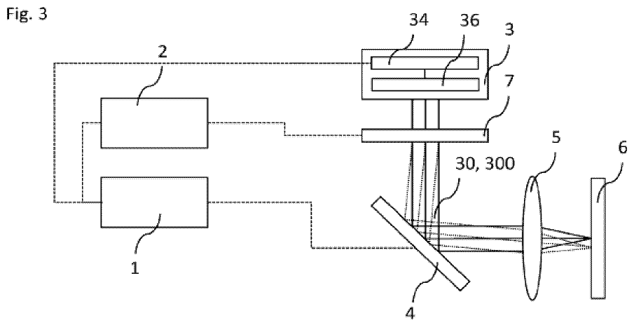

A further possible embodiment of the device is shown in FIG. 3. Here, the laser 3 comprises an unstable seed laser 34 and an amplifier 36. If the seed laser 34 receives a pulse of the base signal from the system clock generator, the seed laser emits a laser pulse that is amplified by the amplifier. The temporal emission of the laser pulse by the seed laser 34 is thus inherently statistically distributed due to the instability.

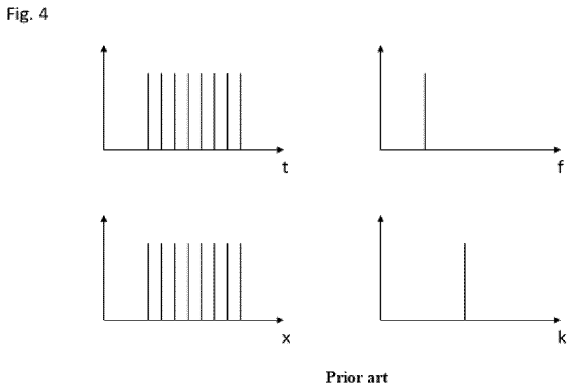

FIG. 4 shows a method according to the prior art. Here, laser pulses are emitted at regular intervals and introduced into the material. The laser pulses therefore only have one temporal frequency, namely the repetition frequency.

While the laser 3 emits laser pulses 300, the material 6 can be moved uniformly relative to the laser beam 30 using a feed device. As a result, the laser pulses 300 on the material 6 also have a uniform spacing such that the laser pulses in the spatial frequency space only have one spatial frequency.

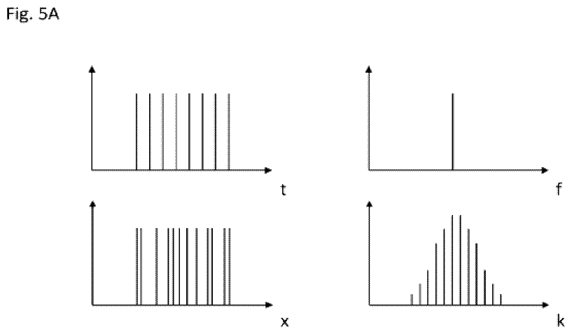

FIG. 5A shows a method according to embodiments of the invention for processing a material 6 by means of laser pulses 300 of a pulsed laser 3, wherein the laser pulses 300 are introduced into the material 6 in order to process the material 6. In the present case, the laser 3 emits laser pulses 300 at a certain frequency, which correspond, for example, to the system clock of a system clock generator 1. Here, the triggered laser pulses fall onto a position offset device 7 from which they are deflected. The position offset device 7 can be controlled via the statistics generator 2, for example. Accordingly, the laser pulses 300 are deflected with the statistical distribution, for example deflected perpendicular to the feed direction. By deflecting the laser pulses 300, the laser pulses are therefore spatially statistically distributed around the feed trajectory.

FIG. 5B shows such a method. The laser beam 30 is periodically moved in a meandering manner over a material 6, while perpendicular to the trajectory the laser pulses are deflected by the position offset device 7. Due to the uniform pulse output, the laser pulses are present in a regular pattern in the y-direction, but have a spatial statistical distribution perpendicular to the meandering structure.

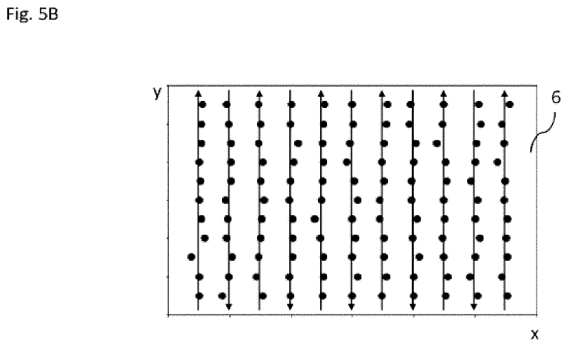

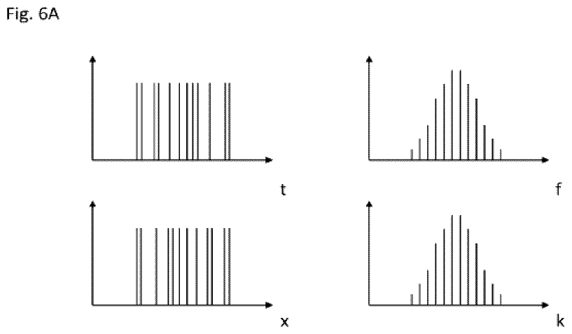

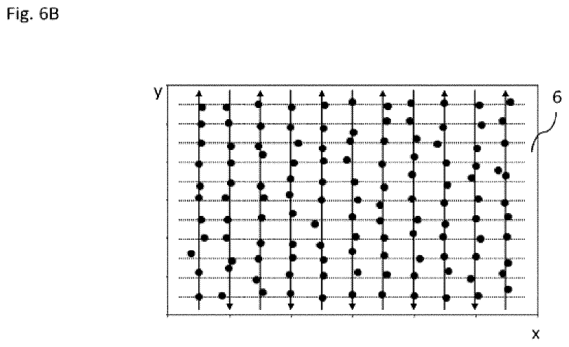

In addition to the spatial statistical distribution by the position offset device 7, however, the laser 3 can also emit laser pulses 300 with a temporal statistical distribution, for example by triggering a pulse-on-demand functionality of the laser 3 by means of the signal of the statistics generator 2. This is shown in FIG. 6A. The temporal statistical variation of the laser pulse output is noticeable with a provided feed in that the laser pulses 300 are also distributed along the feed direction, as shown in FIG. 6B. The laser pulses have a Gaussian distribution in both the x-direction and the y-direction. In particular, the laser pulses 300 are also offset from one another in the feed direction (at a constant feed rate).

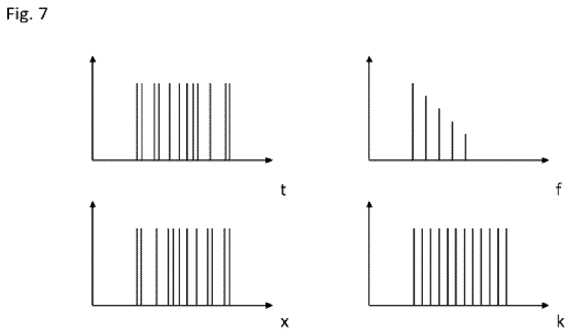

As shown in FIG. 7, it is also possible that the temporal statistical distribution and the spatial statistical distribution are different distributions, for example a triangular distribution and a uniform distribution.

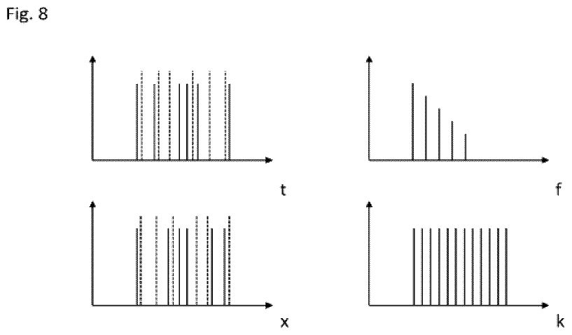

FIG. 8 also shows that the pulses of the system clock signal (dashed lines) can be triggered at irregular intervals, for example because the feed device 4 only outputs such a system clock signal after a certain distance has been traveled. In particular, such an irregular pulse output can occur in the time period at non-uniform speeds. By the statistics generator 2 receiving the signal from the feed device 4, an additional temporal statistical distribution can be imposed such that the laser pulses are introduced into the material 6 at irregular intervals.

Insofar as applicable, all individual features presented in the exemplary embodiments may be combined with one another and/or interchanged.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 System clock generator
2 Statistics generator
3 Laser
30 Laser beam
32 Focus zone
300 Laser pulse
34 Seed laser
36 Amplifier
4 Feed device
40 Axis device
42 Scanner device
400 Feed trajectory
5 Processing optical unit
6 Material
7 Position offset device

1. A method for processing a material by using laser pulses of a pulsed laser, the method comprising introducing the laser pulses into the material in order to process the material,
wherein
the laser pulses are introduced into the material in a distributed manner spatially statistically around a spatial target value, wherein a spatial statistical distribution of the laser pulses is capable of being adjusted and adapted according to a current feed rate.

2. The method according to claim 1, wherein the laser pulses are statistically distributed in at least one spatial dimension.

3. The method according to claim 1, further comprising displacing a laser beam and the material relative to one another with a feed.

4. The method according to claim 3, wherein a feed rate is greater than 50 mm/s.

5. The method according to claim 3, wherein the laser pulses are emitted with a temporal statistical distribution around a temporal target value during the feed.

6. The method according to claim 1, wherein the spatial statistical distribution of the laser pulses corresponds to a Gaussian distribution, or a uniform distribution, or a triangular distribution, or a sawtooth distribution.

7. The method according to claim 1, wherein the spatial statistical distribution has an upper and/or a lower cut-off value.

8. The method according to claim 1, wherein laser pulses emitted in immediate succession do not overlap.

9. The method according to claim 1, wherein a temporal statistical distribution of the laser pulses is adapted according to the current feed rate.

10. A device for processing a material, the device comprising
a system clock generator configured to provide a system clock signal,
a statistics generator configured to receive the system clock signal, and to impose a temporal statistical distribution on the system clock signal to provide a statistics clock signal,
a laser configured to receive the statistics clock signal or the system clock signal, and to emit laser pulses when the statistics clock signal or the system clock signal is received,
a feed device configured to move a laser beam and the material relative to one another, and
a processing optical unit configured to transfer the laser beam to a focus zone, and to introduce the laser beam into the material, thereby processing the material.

11. The device according to claim 10, further comprising a position offset device configured to receive the statistics clock signal, and to impose a spatial statistical distribution around a spatial target value on the laser pulses.

12. The device according to claim 10, wherein the feed device receives the system clock signal or the statistics clock signal.

13. The device according to claim 11, wherein the position offset device comprises an electro-optical and/or acousto-optical deflector, and/or is based on coherent beam combining, wherein the position offset device receives the statistics clock signal and deflects the laser pulses according to the statistics clock signal.

14. The device according to claim 13, wherein the spatial statistical distribution takes place with a clock rate of over 100 kHz.

15. The device according to claim 10, wherein
a wavelength of the laser pulses is between 200 nm and 3000 nm, and/or
a repetition rate of the laser is between 10 kHz and 100 MHz, and/or
the laser pulses comprise a plurality of burst pulses, and/or
a fluence is greater than 0.05 J/cm\hat{ }2, and/or
a laser pulse duration is between 10 fs and 100 ns.

16. The device according to claim 10, wherein the laser beam has a Gaussian beam shape or a non-diffracting beam shape.

17. The device according to claim 10 wherein the laser beam has a flat-top beam shape, and/or a super-Gaussian beam shape, and/or a top-hat beam shape.
